(19) United States
(12) Patent Application Publication
(10) Pub. No.: US 2007/0260471 A1
(43) Pub. Date: Nov. 8, 2007

(54) INTERFACE BETWEEN DEALER MANAGEMENT SYSTEM AND FLUID DELIVERY SYSTEM

(75) Inventors: Eric Krassinger, St. Louis, MO (US); Diane Bicknese, Defiance, MO (US); Cullin Wible, New York, NY (US)

Correspondence Address: SENNIGER POWERS, ONE METROPOLITAN SQUARE, 16TH FLOOR, ST LOUIS, MO, 63102, US

(73) Assignee: LINCOLN INDUSTRIAL CORPORATION, St. Louis, MO (US)

(21) Appl. No.: 11/460,356

(22) Filed: Jul. 27, 2006

Related U.S. Application Data
(60) Provisional application No. 60/746,247, filed on May 2, 2006.

(51) Int. Cl. G06Q 10/00; G06Q 30/00; G06F 9/44

(52) U.S. Cl. 705/1; 705/7

(57) ABSTRACT

A dealer management system (DMS) and a fluid dispensing system are linked by a computer. An interface, which may be integral with a dispenser control, is executed by the computer for providing to the DMS dynamic information for a particular repair order. The information is provided to the DMS in response to fluids dispensed by the fluid dispenser and in response to repair information input via an input device.

### FIELD OF THE INVENTION

The present invention generally relates to an automotive dealer management system (DMS) and to a fluid delivery systems used in conjunction with dealer management system. In particular, the invention relates to an interface establishing communication and dynamic interaction between the dealer management system and the fluid delivery system.

### BACKGROUND OF THE INVENTION

Most automotive businesses which are involved in sales and/or service use a computer based system to manage inventory and repair orders. Such systems, frequently referred to as dealer management systems or DMS, vary in size and complexity depending upon the size and needs of the business. In addition, a DMS interfaces with other systems at various levels. For example, a DMS may receive or provide certain information to other systems, such as dispensing systems, parts management systems and/or repair order scheduling systems. There is a need for better integration of information between a DMS and a fluid dispensing system.

There are many reasons to integrate a fluid control system of a service shop into the shop's DMS accounting software. Some of these reasons are: automate billing process, dispense only valid repair orders, manage lubricant inventory, increase service bay efficiency, and prevent misallocation of product.

Benefiting owners, service managers and parts managers, a fluid control system saves time and money through automatic billing and by creating a smooth flow throughout the garage. Customizing the fluid control system allows mechanics controlled access to lubricants and other fluids without leaving their bays.

A fluid control system can confirm valid and open repair orders on your dealer management system. Dispensing events are captured instantly and automatically to eliminate manual entering and errors. Accounting functions are completed accurately on the repair order and invoice, recording inventory depletion and eliminating lost billings.

### SUMMARY OF THE INVENTION

Most automotive dealers use a dealer management system (DMS) which frequently include such functions as managing and invoicing repair orders (RO). Service technicians are required to enter into the DMS via a keypad, touch screen or other input device various information about the work being done and the parts being used. The amount of information that must be entered depends on the type of DMS and the particular work to be preformed in accordance with the RO.

In the course of the work being performed, a service technician may use a fluid delivery system to dispense motor oil, transmission fluid, antifreeze, windshield washer or some other automotive fluid. Some fluid delivery systems are independent of the DMS and require the technician to input information indicative of fluids dispensed. As a result, a percentage of fluid deliveries and parts associated with such deliveries (e.g., oil, oil filters, replacement parts, etc.) tend to be billed improperly or not at all.

There is a need for an interface between the DMS and the fluid delivery system which would provide dynamic information from the fluid delivery system to the DMS.

Other features will be in part apparent and in part pointed out hereinafter.

### BRIEF DESCRIPTION OF THE DRAWINGS

FIG. 1 is a block diagram of an overview of the combination of a dealer management system server, a fluid dispensing system and associated keypads and other components, according to one embodiment of the invention.

FIG. 2 illustrates an interface for communicating between a computer and a DMS server and for inserting dynamic information into the repair orders of the DMS server, according to one embodiment of the invention.

FIG. 3 is a flow chart of a process from the perspective of dispenser control software according to one embodiment of the invention.

FIG. 4 is a flow chart of a process from the perspective of interface software according to one embodiment of the invention.

FIG. 5 is a flow chart of a process from the perspective of dispenser control software according to one embodiment of the invention employing real time communication so that the master PC is interfacing directly with the DMS server.

FIG. 6 illustrates a series of keypad screen shots of one example of a default configuration of one embodiment of the invention.

FIG. 7 is a screen shot of one example of one embodiment of a default configuration of the invention.

FIG. 8 illustrates a series of keypad screen shots of one example of one embodiment of the invention implementing configuration 1.

FIG. 9 is a screen shot of an example of configuration 1 of one embodiment of the invention.

FIG. 10 illustrates a series of keypad screen shots of one example of one embodiment of the invention implementing configuration 2.

FIG. 11 is a screen shot of an example of configuration 2 of one embodiment of the invention.

FIG. 12 is a screen shot of one example of one embodiment of a display of a transaction text file received by the interface from the dispenser control software indicative of a dispense, according to one embodiment of the invention.

Corresponding reference characters indicate corresponding parts throughout the drawings.

### DETAILED DESCRIPTION OF THE INVENTION

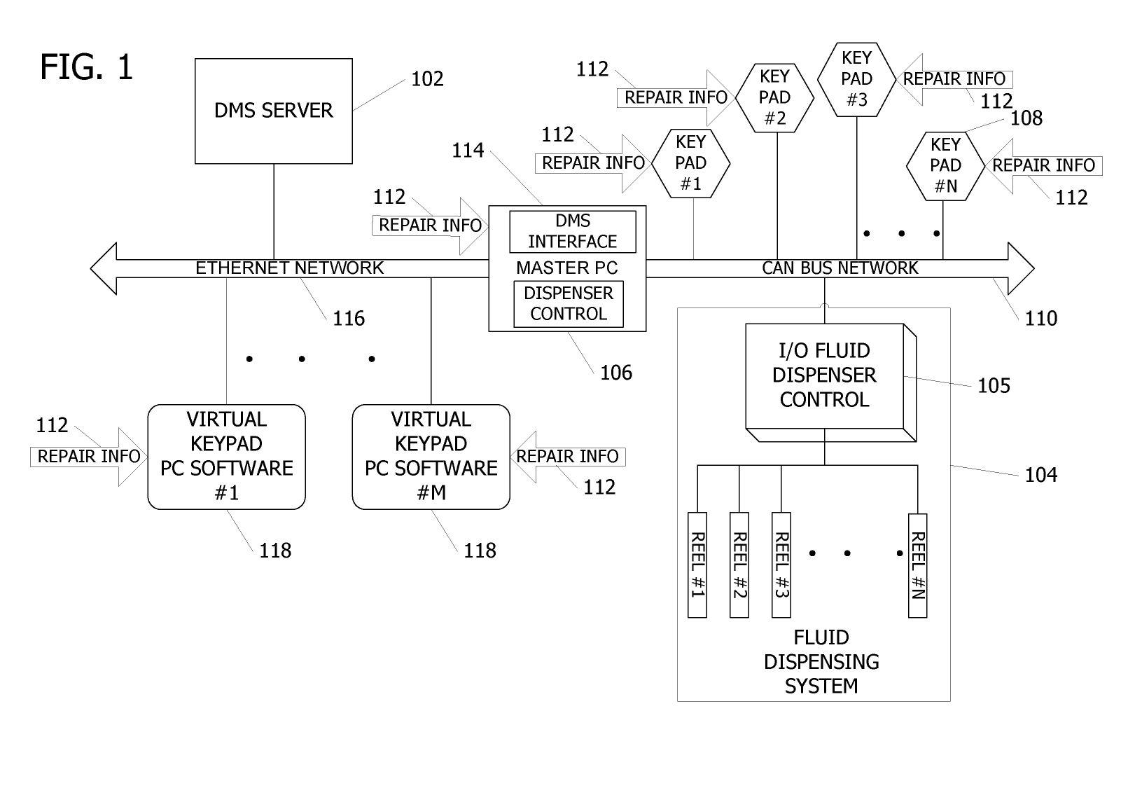

### System Overview (FIG. 1)

FIG. 1 is a block diagram of an overview of the combination of a dealer management system server 102, a fluid dispensing system 104 and associated keypads and other components, according to one embodiment of the invention. The dealer management system (DMS) executed by a DMS server 102 is used by an automotive dealer or other repair facility for managing repair orders (RO) for repairs to be performed in a service department. The fluid dispensing system 104 is operated by a service technician for dispensing fluids in the service department. In particular, the fluid dispensing system 104 includes a fluid dispenser control 105 which controls a plurality of reels, each for dispensing a different fluid. For example, each reel could dispense one of the following: motor oils of various grades, transmission fluids of various types, antifreeze of various types, windshield washer or some other automotive fluid.

A computer 106, frequently referred to as a Master PC, links the dealer management system server 102 and the fluid dispensing system 104. A plurality of keypads 108 are linked to the computer by a network such as a controller area network (CAN) 110. It is contemplated that any type of link may be used, such as a wireless link, or other network link, including but not limited to an Ethernet link or a proprietary configuration. The keypads or a keyboard of the computer 106 or any other input device connected to either network, either directly or indirectly, may be used by service technicians in the service department to input repair information 112 relating to the repair orders. At least some of the keypads 108 are located within the service department (e.g., within service bays) while others keypads may be located in a business office, in a service manager's office, in a parts department and/or any other location within the dealership.

In one embodiment, it is contemplated that the system would also include an Ethernet network 116 linked to the computer 106 and including one or more virtual keypads 118. For example, the virtual keypads 118 may be personal computers located within the service department and executing virtual keypad PC software so that service technicians can use the virtual keypads to input repair information 112 into the system.

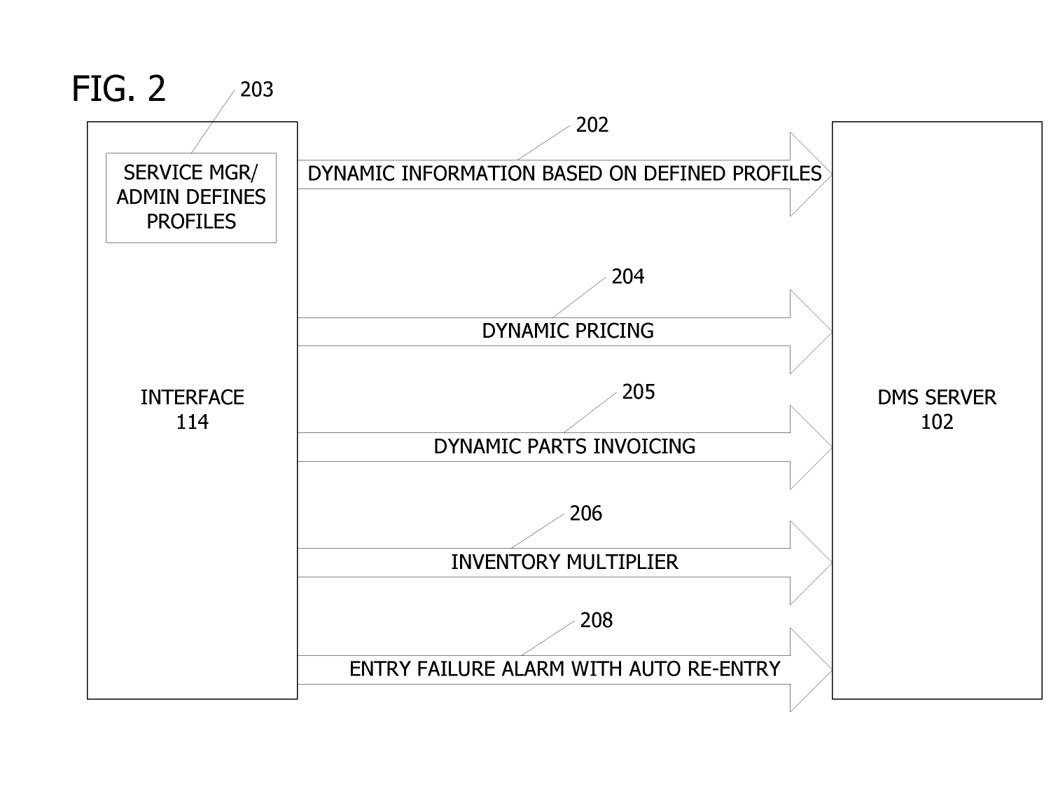

A DMS interface 114 executed by the computer 106 provides to the DMS server 102 for a particular repair order dynamic information based on profiles including pricing information previously defined by a service manager or authorized administrator (see FIG. 2). In one embodiment, the interface 114 provides the dynamic information to the DMS server 102 in response to fluids dispensed by the fluid dispensing system 104 and in response to repair information 112 input via one of the keypads 108 by a service technician.

### Dynamic Information (FIG. 2)

FIG. 2 illustrates the DMS interface 114 for communicating between the computer 106 (Master PC) and the DMS server 102 and for inserting dynamic information 202 into the repair orders of the DMS server 102, according to one embodiment of the invention. In general, the information provided from the interface 114 to the DMS is configured in advance by a service manager, authorized administrator or other supervisory authority.

In one embodiment, the dynamic information 202 includes dynamic profiles which are specified by the advanced configuration. In one embodiment, the dynamic information includes any information which is modified to adjust price, quantity, inventory or materials billed. For example, dynamic price information includes a price which is adjusted so that the price charged is different than the price of the material used (e.g., a flat price regardless of the amount of fluid dispensed). As another example, dynamic quantity information includes a quantity which is adjusted so that the quantity charged is different than the quantity of the material used (e.g., a flat quantity regardless of the amount of fluid dispensed). As another example, dynamic inventory information includes adjusting the inventory so that the amount relieved from inventory reflects the quantity of the material used and is different than the quantity charged (e.g., relieving inventory based on actual amounts dispensed while charging for a flat quantity). As another example, dynamic materials billed information includes adjusting the parts billed to include parts not identified but associated with other parts (e.g., billing a filter in combination with an oil dispense).

### Dynamic Pricing

In one embodiment according to the invention, the dynamic information comprises dynamic pricing 204. The interface 114 specifies or adjusts dynamically the price (according to the selected pricing profile, noted below) while correctly relieving the amount of inventory that was actually dispensed. As an example, assume that the dynamic pricing rule is that all dispensed quantities are rounded upward to the nearest whole quart and billed based on the rounded whole quart. Thus, if 4.1 quarts are dispensed, the interface 114 would provide the DMS server the dynamic price in effect at that time for 5 quarts. Similarly, if 4.9 quarts are dispensed, the interface 114 would provide the DMS server the dynamic price in effect at that time for 5 quarts. If 5.1 quarts are dispensed, the interface 114 would provide the DMS server the dynamic price in effect at that time for 6 quarts.

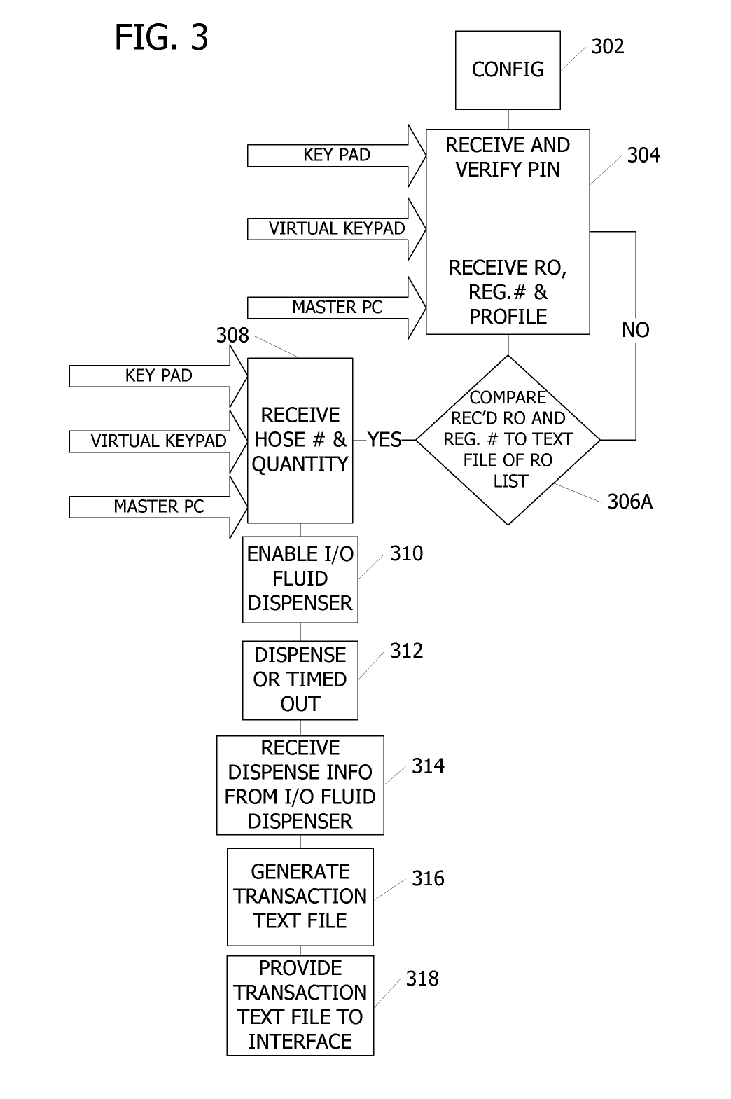

The process of transferring the dynamic pricing from the interface 114 to the DMS 102 will be described below with regard to FIGS. 3, 4 and 5. In one embodiment, as noted below, the DMS server 102 maintains an inventory of the fluids and the interface 114 provides information to the DMS server 102 to relieve the inventory based on the actual amount of dispensed fluid independent of the specified amount on which the price is based.

In dynamic pricing, the interface 114 provides to the DMS server 102 information specifying a dynamic price of the dispensed fluid based on the amount of fluid dispensed. The specified dynamic price is applied to the particular repair order. For example, the interface 114 provides the dynamic pricing information 202 to the DMS server 102 in response to fluids dispensed by the fluid dispenser under the service technician's control and in response to repair information 112 input via one of the keypads 108, 118 by the service technician.

### Dynamic Parts Invoicing

Another aspect of dynamic information 202 is dynamic parts invoicing 205. In this embodiment, the interface 114 provides to the DMS server 102 dynamic information identifying an additional part related to a particular part (according to the selected invoicing profile, noted below). For example, an oil filter may be an additional part related to dispensed fluid. In this configuration, when a service technician enters the particular part to be added to a repair order, the interface 114 automatically enters in the repair order the particular part and any additional parts related to the particular part. As a specific example, an oil filter may be configured to be related to dispensed oil so that the entry would result in the interface automatically entering the oil filter. Thus, if the technician enters dispensed oil to be billed to an RO, an oil filter would also be billed In particular, when the fluid dispensing system indicates that motor oil for a oil change has been dispensed, the interface 114 would indicate to the DMS server that the repair order should include both the dispensed oil and a charge for an additional part, an oil filter.

### Profiles (FIG. 2)

In one embodiment, the interface 114 to the DMS may be configured in advance by a service manager or other supervisory authority via a display (such as the keypad 108, 118 or a computer display) according to one of a plurality of profiles 203, such as pricing profiles, rounding profiles, invoicing profiles and/or inventory profiles. The service manager defines various profiles which may be selected by a service technician when the service technician enters the repair information. For example, the profiles may be pricing profiles including one or more of the following:

(1) DMS Dispense—This may be a default pricing profile that calculates the pricing based on the quantity dispensed and the pricing matrices stored in the DMS.

(2) Fixed Dispense—This pricing profile uses a fixed price for each part but updates the quantity based on the amount of fluid dispensed. The actual sale price may be off by several cents, since the sale price is divided by the quantity dispensed and rounded to the nearest cent.

(3) DMS Fixed—In the pricing profile, a fixed quantity is used and the sale price is based on the pricing matrices stored in the DMS.

(4) Fixed—This pricing profile uses a fixed quantity and a fixed price for each part.

(5) Price Dispense—This pricing profile is based on a fixed price per quart. The total price charged is the quantity dispensed with selected rounding times the fixed price per quart. For example, if the price dispense was set at $3.00 per quart, the interface will implement a charge of $3.00 per quart to the final sale quantity. If 2.6 quarts is dispense and the rounding technique is “standard>1”, the interface will round to 3 quarts and charge the 3 quarts at $3.00/quart for a total of $9.00.

Other examples of pricing profile may be early bird pricing wherein various groups of products are all billed at the same early bird price or preferred customer pricing or fluid only pricing for a particular type of dispense, such as a fluid top-off.

It is also contemplated that a particular profile may be designated as applicable or available for a particular time period. For example, an early bird pricing profile may be applicable for all entries before 10 am and entries after 10 am may be based on a different profile or a default profile.

In general, the particulars of the profile may not be known to the service technician and would be specified by the service manager or administrator as part of the system configuration in advance. In one embodiment, the service technician would enter a profile identifier along with a registration number which identifies the line item of the RO (see below). The entered profile in place at the time of entry would determine how to modify the RO. One advantage of this embodiment of the invention is that it requires the technician to enter a minimum amount of information yet the system is able to provide complete billing of all related parts. There is no need for the technician or parts manager to separately enter actual billing details, actual inventory relief information or related parts information (e.g., an oil filter) in an RO. When oil is dispensed and added to an RO, the dynamic pricing and invoicing features would automatically add to an RO the oil filter along with the oil dispensed and bill the rounded price.

In one embodiment, the defined profiles specified at 203 in advance by a service manager or other supervisory authority via a display (such as the keypad 108, 118 or a computer display) may optionally include one of a plurality of rounding profiles, any of which may be associated with a particular profile. For example, the service manager may select one of the rounding profiles to be part of a defined pricing profile. For example, the rounding profiles may include:

(1) Standard Rounding—This profile uses a standard arithmetical rounding method in which dispensed quantities ending from 0.01 to 0.49 are rounded down to the nearest whole number and dispensed quantities ending from 0.50 to 0.99 are rounded up to the nearest whole number.

(2) Standard Rounding>1—This profile uses a standard arithmetical rounding method in which dispensed quantities ending from 0.01 to 0.49 are rounded down to the nearest whole number and dispensed quantities ending from 0.50 to 0.99 are rounded up to the nearest whole number except that total quantities greater than 0 and less than 0.50 are rounded to 1.

(3) Round Up—Quantities are always rounded up to the next whole number.

(4) Round Down—Quantities are always rounded down to the next whole number.

(5) Round Down>1—Quantities are always rounded down to the next whole number except that total quantities greater than 0 and less the 0.50 are rounded to 1.

### Inventory Multiplier (FIG. 2)

In one embodiment, the interface 114 to the DMS may be configured in advance by a service manager or other supervisory authority to present an inventory multiplier 206 adjusting inventory information supplied by the interface 114 to the DMS server 102. This may be implemented as a system-wide setting. For example, some dealer management systems only store inventories in whole numbers so that some DMS servers maintain inventories using a decimal-free notation in tenths without using decimals. In this type of inventory system, 5.0 quarts would be shown as 50 quarts and 6.2 quarts as 62 quarts. The interface 114 can be programmed to communicate with the DMS server using the decimal free notation. For example, if a service technician enters a dispense of 6.2 quarts, the inventory would be relieved by 62 quarts, the RO would include a line item for 62 quarts and the pricing and billing would show and be based on 6.2 quarts. Thus, the inventory multiplier scales the inventory information supplied by the interface to the DMS so that the supplied information corresponds to the scale of the inventory information in the DMS and so that the inventory of the DMS is adjusted at a rate which corresponds to the actual use.

### Entry Failure Alarm (FIG. 2)

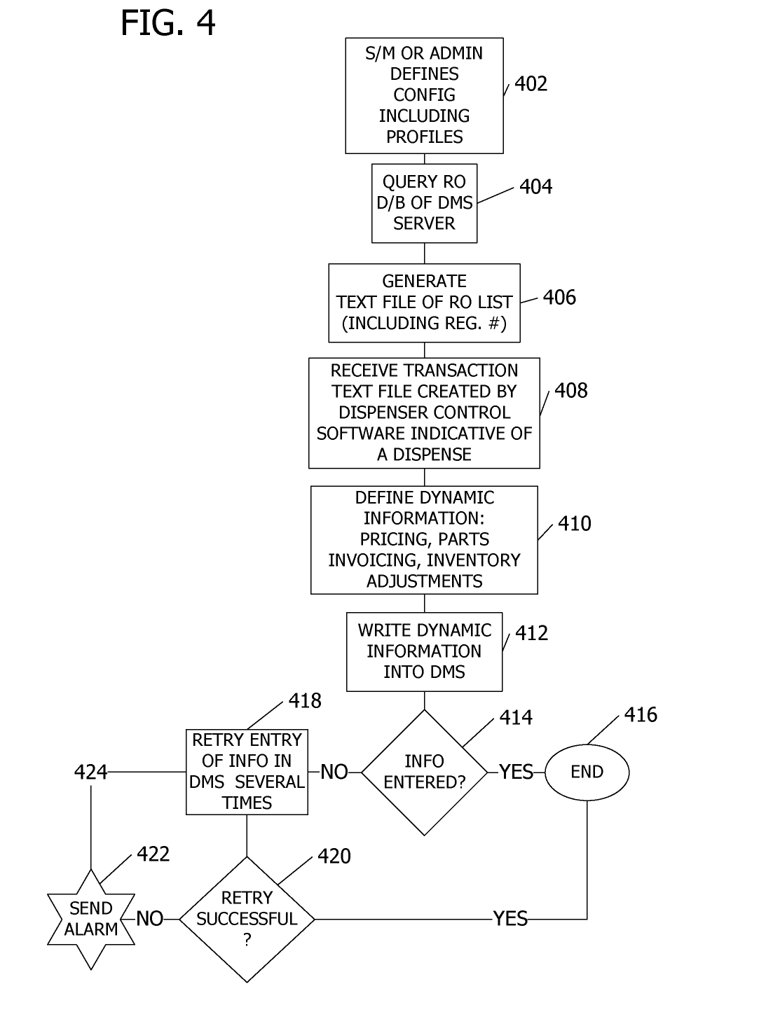

In one optional embodiment, the interface 114 to the DMS may be configured in advance by a service manager or other supervisory authority to present an entry failure alarm 208 in the event that repair information 112 is not written to the DMS server 102 because such writing was inhibited or blocked or interrupted. For example, an RO may be inaccessible to the interface because it is locked, closed, in read only status or being accessed by another technician. The alarm will be explained in greater detail below regarding FIG. 4.

### Dispenser Control (FIG. 3)

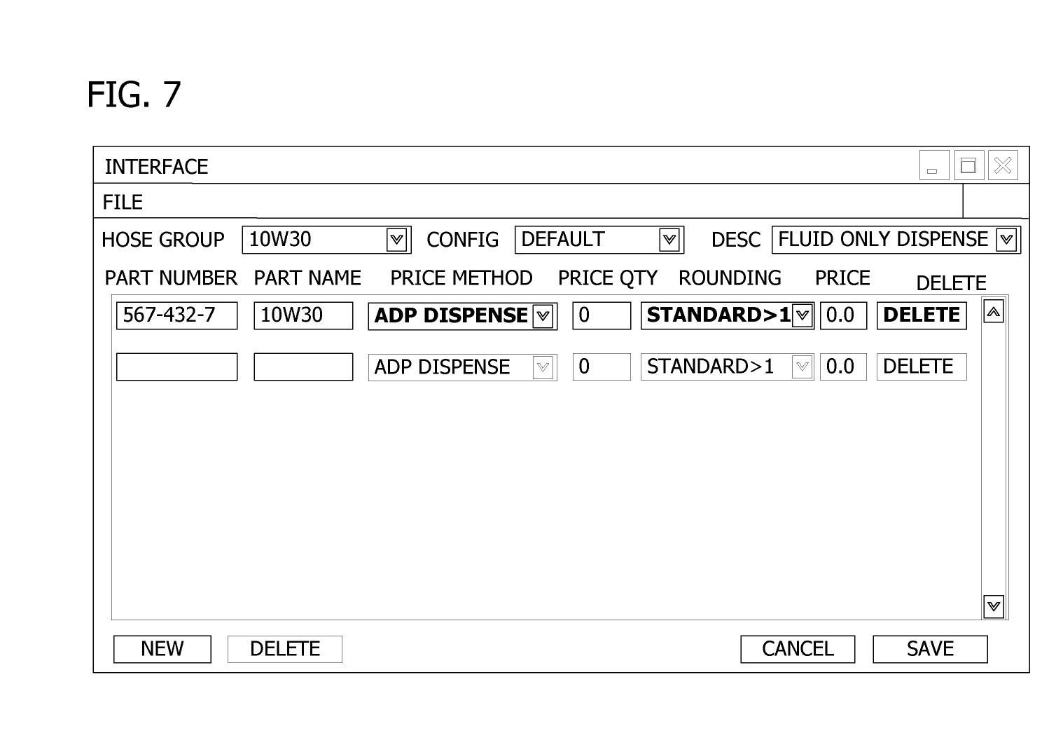

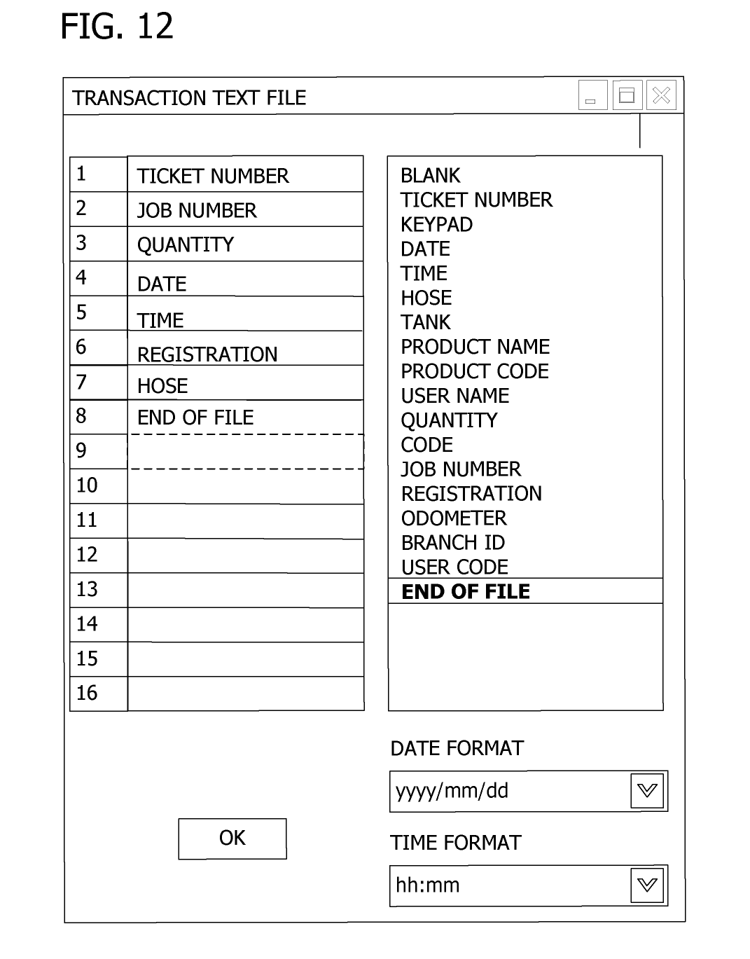

FIG. 3 is a flow chart of a process from the perspective of dispenser control software according to one embodiment of the invention. As illustrated in FIG. 3, the computer executes dispenser control software for generating a transaction text file indicative of fluids dispensed by the fluid dispenser. After profile configuration information is provided by a service manager or other administrator to the dispenser control software at 302, the dispenser control software is operational and awaiting input from a service technician regarding an RO at 304. As indicated, the input may come from keypads 108, virtual keypads 118 or the computer 106. After receiving an authorized PIN number, an RO number, a registration number (e.g., line item of the RO), and a profile designator are input by the service technician (see FIGS. 7-9, below). At 306A, the received RO and registration number are compared to a text file of a list of open and active ROs. (See FIG. 4 regarding the generation of this text file list.) If the received RO and registration number do not match an RO and registration number on the list, the dispenser control software indicates an error to the service technician and returns to await another entry at 304. If the received RO and registration number matches an RO on the list at 306A, the dispenser control software prompts the service technician at 308 to identify the hose number and fluid quantity that will be dispensed by the hose number. Preprogrammed dispensing modes include a preset quantity dispense mode in which the technician enters a preset quantity to be dispensed by the fluid dispensing system 104 or a free or “on demand” dispense mode in which the technician is permitted to dispense any amount within a preset period of time and the fluid dispensing system 104 measures the amount dispensed. The dispenser control software then enables at 310 the I/O fluid dispenser control 105, which is followed by the service technician dispensing the fluid at 312 or the dispenser control software times out (e.g., no action by the service technician after a set period of time). Thereafter, at 314 the dispenser control software receives information from the I/O fluid dispenser control indicating that the preset amount of fluid has been dispensed (in the preset dispense mode) or that a given amount of fluid has been dispensed (in the on demand mode). The dispenser control software at 316 generates a text file reflecting the transaction (see FIG. 12, below) and at 318 provides the text file to the interface 114.

### DMS Database Query (FIG. 4)

FIG. 4 is a flow chart of a process from the perspective of the interface software according to one embodiment of the invention. In this embodiment, the DMS server 102 has a database of repair orders. After the interface 114 is configured by the service manager or other authorized administrator with one or more of a plurality of profiles at 402, the interface 114 queries the DMS RO database at 404 to generate at 406 a text file listing the active and open ROs and their line numbers (e.g., registration numbers). This list is used as indicated at 306A in FIG. 3 to verify repair information 112 entered by a service technician. At 408, the interface 114 receives from the dispenser control software a transaction text file created by the dispenser control software at 318 indicating that work has been completed (e.g., a fluid has been dispensed). At 410, the interface selects pricing, related parts and rounds amounts according to previous configurations and according to the profile entered by the service technician. If no profile is entered, a default profile is applied.

At 412 the interface software writes the dynamic information in the RO in the DMS database. At 414, the interface software confirms that the information is entered in which case the process ends at 416. In the event that the interface is unable to confirm entry of the information into the RO at 414, the interface proceeds from 414 to 418 to retry entry for several (e.g., 5) times. At 420, the interface confirms that the retry has been successful in which case the process ends at 416. In the event that the interface is unable to confirm the retry at 420, the interface proceeds from 420 to 422 to provide an alarm to the service technician, to the service manager and/or to someone designated to respond. For example, the alarm may be provided to a service manager who can clear or change the status of the RO so that it can be written to. After clearing or changing the RO, the manager could instruct the interface to retry entry, as indicated by line 424.

In one embodiment, the DMS may provide code or other indication to the interface for the reason that the transaction has not been entered. For example, the DMS may indicate the status of the RO (e.g., read only). This information may be provided with the alarm. Further, the interface may have a table which provides text corresponding to codes. For example, a 123 code may mean read only and the table would cross reference 123 to a statement such as “RO is read only”. This text corresponding to the code would be provided as the alarm message or as part of the alarm message.

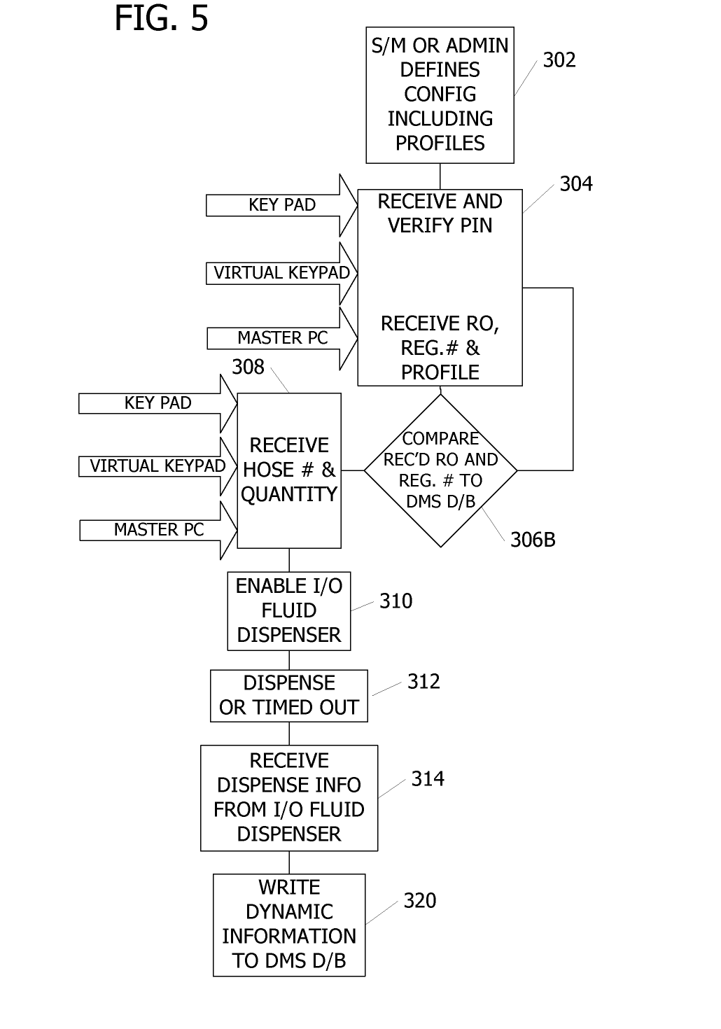

### Integrated, Real-Time System (FIG. 5)

FIG. 5 is a flow chart of a process from the perspective of dispenser control software according to one embodiment of the invention employing real time communication wherein the master PC is interfacing directly with the DMS server. In other words, in this embodiment, the interface 114 is integrated into the dispenser control software. This process is similar to FIG. 3 so that the same reference characters used in FIG. 3 are used in FIG. 5 to refer to the same operations. One difference is that at 306B the received RO and registration number are compared directly and in real time to the RO database (D/B) managed by the DMS server and no text file of the RO list (see 406 of FIG. 4) is created or needed. Another difference is that at 320 the integrated software of FIG. 5 writes the dispense information received from the I/O fluid dispenser 105 directly and in real time to the RO database managed by the DMS server 102.

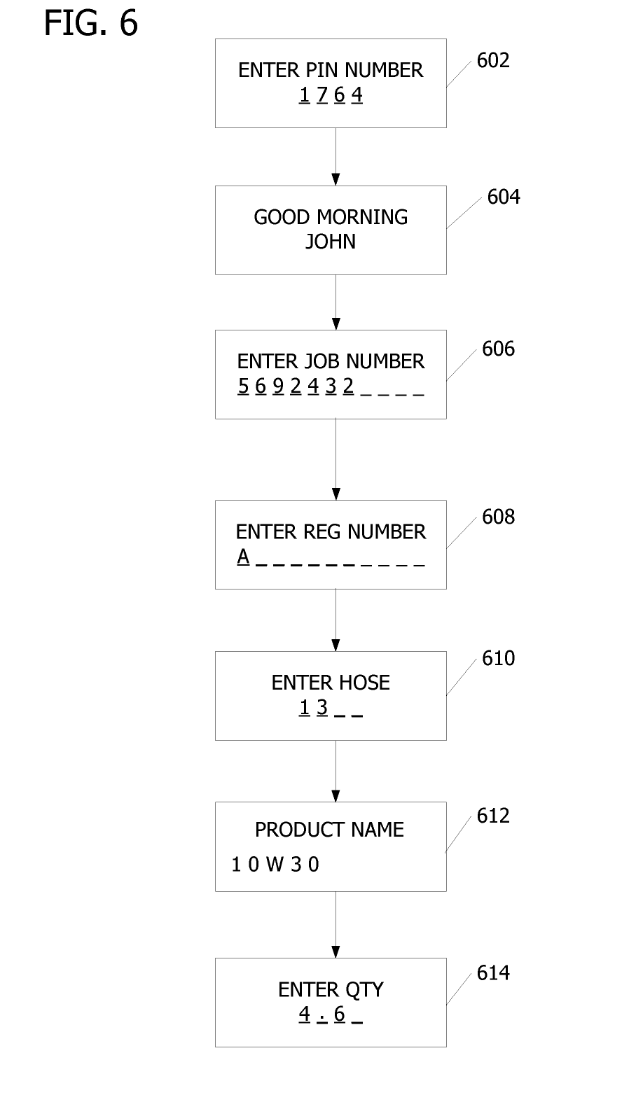

### Default Configuration (FIGS. 6 and 7)

FIGS. 6 and 7 illustrate an example of a dispense according to a default configuration that only records to the DMS the fluid rounded up to the nearest whole number.

The service technician enters their pin number at 602 which is verified. The service technician next enters the RO number (5692432) at 606 for the job number field. Next, at 608 the service technician enters the line code associated with the oil change in the registration number field. In this example, the service technician enters only an “A” and does not enter a profile designation. As a result, the interface automatically selects the default configuration setup in the interface, as illustrated in FIG. 7. The system then verifies that the RO number and line code exist within the DMS database and check to see if the RO is open to write to. Next, at 610, the service technician is allowed to enter the hose number to be used which is verified by the control system. At 612, the product name is displayed on the keypad to the service technician. Next, at 614 the service technician enters in the quantity to be dispensed (e.g., 4.6 quarts) which enables the hose to pump the fluid. Alternatively, at 614 the service technician could enter a code for “on demand” dispense (not shown).

The service technician pumps the 4.6 quarts into the vehicle and the dispense is completed. The dispense results are returned to the Master PC software. The dispense results include the transaction internal ticket number, RO number, quantity dispensed, date of dispense, time of dispense, line code, and hose number (see FIG. 12). The interface application grabs the dispense results and writes the dispense information to the DMS on RO 5692432 line A using the default configuration parameters. In this case, it writes to the RO 5 quarts of oil at the price determined in the DMS under the part number 567-432-7 for 5 quart of 10w30 (see FIG. 6). The inventory level in the DMS is relieved by 4.6 quarts.

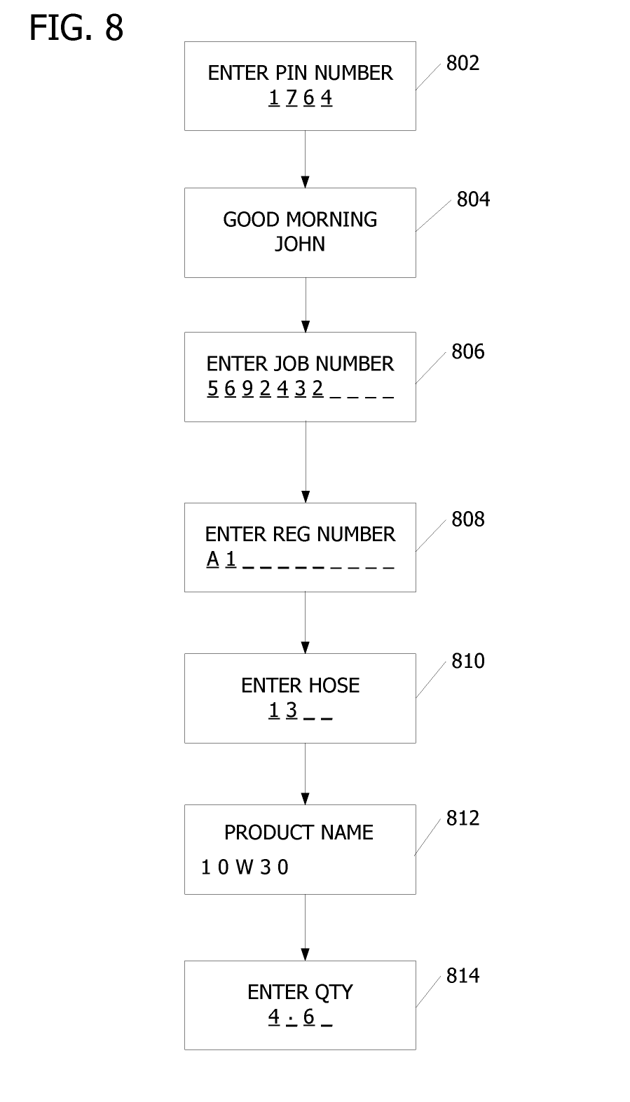

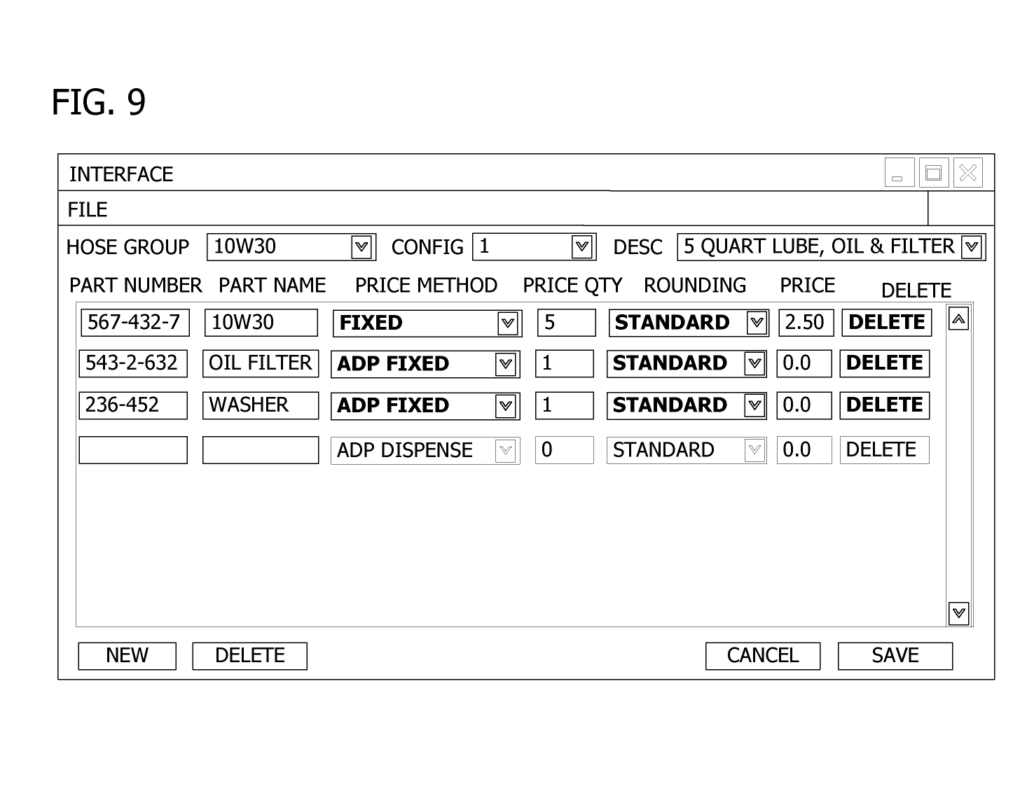

### Configuration 1 (FIGS. 8 and 9)

FIGS. 8 and 9 illustrate an example of a dispense for a lube, oil, and filter service using configuration 1. According to configuration 1 (as defined for this example), the interface will charge the oil at a pre-specified quantity of 5 quarts for $2.50 a quart upon dispense of the fluid, regardless of the actual volume of oil dispensed. One oil filter and washer is also added at the pricing determined within DMS. The inventory will be relieved based on the actual volume of oil dispensed.

The service technician enters their pin number at 802 which is verified by the system at 804. The service technician enters at 806 the RO number (5692432) for the job number field. Next, the service technician enters at 808 the line code associated with the oil change in the Reg. number field. In this example the service technician enters in line code “A1.” The first character “A” designates the line code and the second character “1” is a designation of the profile to apply. Thus, the system automatically selects the configuration 1 setup in the interface, as illustrated in FIG. 9. The system then verifies that the RO number and line code exist within the DMS database and check to see if it is open to write to. The service technician is allowed to enter at 810 the hose number to be used if the verification is successful. The system shows the product name on the keypad at 812. Next, the service technician enters at 814 the quantity of 4.6 quarts which enables the hose to pump the fluid (or enters “on demand”).

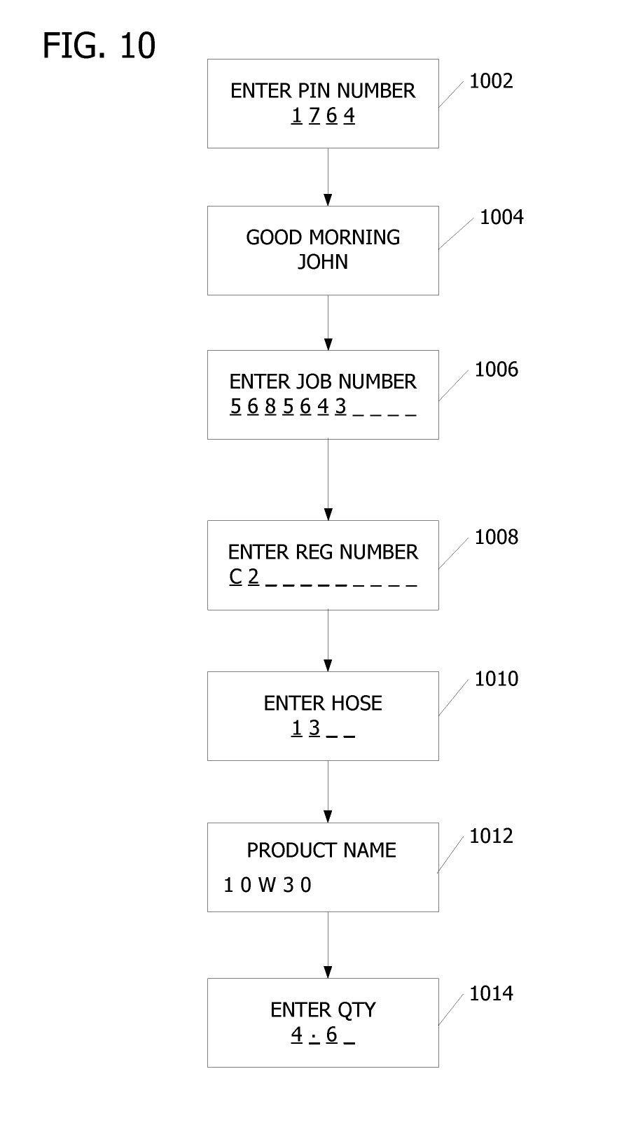

The service technician pumps the 4.6 quarts into the vehicle and the dispense is completed. The dispense results are returned to the Master PC software. The dispense results comprise the transaction internal ticket number, RO number, quantity dispensed, date of dispense, time of dispense, line code, and hose number (see FIG. 12). The interface application grabs the dispense results and writes the dispense information to the DMS on RO 5692432 line A using the configuration 1 parameters. In this case, it writes to the RO 5 quarts of oil at $2.50 a quart under the part number 567-432-7. It also writes 1 oil filter, part number 543-2-632, to the specified RO number and line code because this part number is dynamically added according to configuration 1. It also writes one washer, part number 236-452, to the RO number and line code because this part number is dynamically added according to configuration 1. See FIG. 10. The inventory level in the DMS is relieved by 4.6 quarts. The pricing for the filter and washer is the price set in the DMS for each part number. Rounding methods do not pertain to any of the 3 parts because a fixed pricing quantity is part of configuration 1. Also, according to configuration 1, oil will be billed out at 5 quarts no matter what quantity is dispensed. It could be 3 quarts or it could be 6 quarts but it will always bill out 5 quarts.

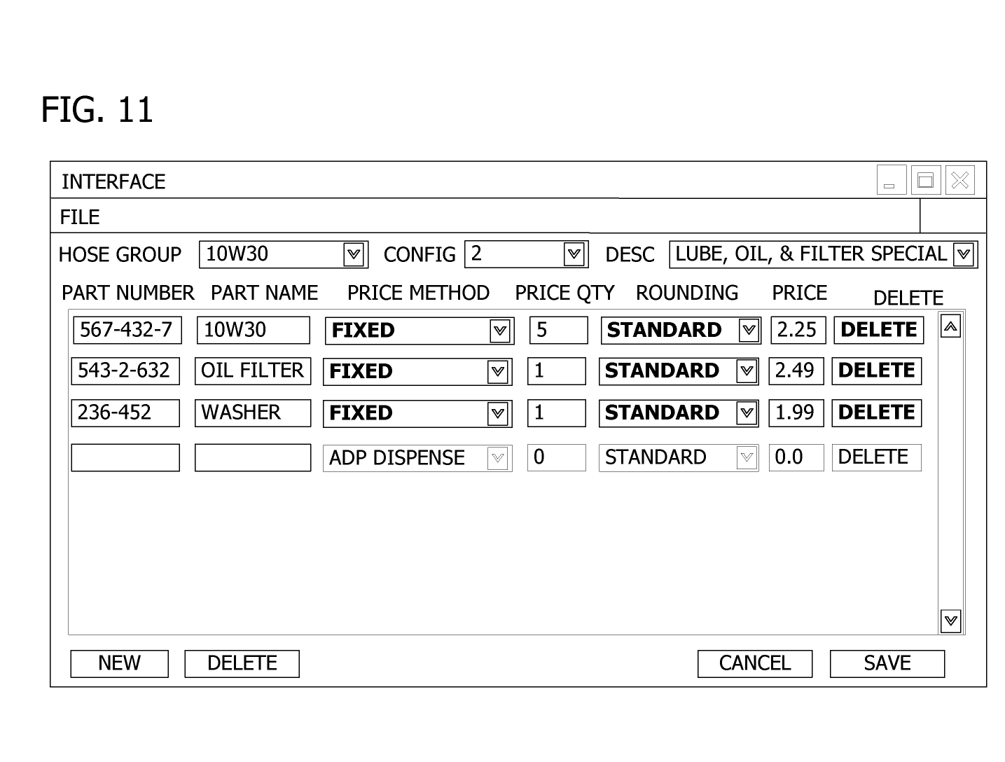

### Configuration 2 (FIGS. 10 and 11)

FIGS. 10 and 11 illustrate an example of a dispense for a lube, oil, and filter service using configuration 2, which for this example is defined as an bird special promotion. According to this configuration 2, upon dispense of the fluid, the system will charge the oil, filter, and washer at predetermined quantities and prices. The total sales price will always add up to $19.99 no matter what quantity of oil was dispensed.

The service technician enters their pin number at 1002 and it is verified by the system at 1004. The service technician then enters at 1006 the RO number (5685643) for the job number field. Next, the service technician enters at 1008 the line code associated with the oil change in the Reg. number field. In this example, the service technician enters in line code “C2” which automatically indicates line C and results in the selection of configuration 2 in the interface, as illustrated in FIG. 11. The system then verifies that the RO number and line code exist within the DMS database and check to see if it is open to write to. At 1010, the service technician next enters the hose number to be used. Upon successful verification, the service technician is shown the product name on the keypad at 1012. Next, the service technician enters at 1014 in the quantity of 4.6 quarts which enables the hose to pump the fluid.

The service technician pumps the 4.6 quarts into the car and the dispense is completed. The dispense results are returned to the Master PC software. The dispense results comprise the transaction internal ticket number, RO number, quantity dispensed, date of dispense, time of dispense, line code, and hose number (see FIG. 12). The interface application grabs the dispense results and writes the dispense information to the DMS on RO 5685643 line C using the configuration 2 parameters. In this case, it writes to the RO 5 quarts of oil at $2.25 a quart under the part number 567-432-7. It also writes one (1) oil filter, part number 543-2-632, to the specified RO number and line code for $2.49. It also writes one (1) washer, part number 236-452, to the RO number and line code for $1.99. The inventory level in the DMS is relieved by 4.6 quarts. Rounding methods do not pertain to any of the 3 parts because a fixed pricing quantity is selected for each one. Using configuration 2, oil will be billed out at 5 quarts no matter what quantity is dispensed. It could be 3 quarts or it could be 6 quarts but it will always bill out 5 quarts.

Having described the invention in detail, it will be apparent that modifications and variations are possible without departing from the scope of the invention defined in the appended claims.

The above non-limiting examples are provided to further illustrate the present invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A system comprising:
A dealer management system (DMS) for managing repair orders for repairs to be performed in a service department;
A fluid dispensing system responsive to a service technician for dispensing fluids in the service department;
A computer linking the dealer management system and the fluid dispensing system; and
An interface executed by the computer for providing to the DMS dynamic information for a particular repair order, said interface providing the information to the DMS in response to fluids dispensed by the fluid dispenser.

2. The system of claim 1 further comprising a plurality of input devices linked to the computer for inputting repair information relating to the repair orders, at least some of said input devices located within the service department and wherein the dynamic information includes dynamic pricing, and wherein the interface provides to the DMS information specifying a price of the dispensed fluid based on the amount of fluid dispensed and in response to repair information input via one of the input devices by a service technician, said specified price applied to the particular repair order.

3. The system of claim 2 wherein the DMS maintains an inventory of the fluids and wherein the interface provides information to the DMS to relieve the inventory based on the amount of dispensed fluid independent of the amount of fluid on which the specified price is based.

4. The system of claim 1 wherein the dynamic information includes dynamic parts invoicing wherein the interface provides to the DMS information identifying one or more parts to be added to the particular repair order along with a price for the dispensed fluid.

5. The system of claim 2 wherein the interface is configurable to have one or more of a plurality of profiles selected by a service technician via one of the input devices and wherein the dynamic information corresponds to one of the profiles to be applied to the particular repair order.

6. The system of claim 5 wherein a particular profile comprises one of the following:
A profile designated as applicable for a particular time period;
A pricing profile;
A rounding profile,
An invoicing profile; and
An inventory profile.

7. The system of claim 1 wherein the interface includes profiled rounding comprising said interface configurable to have one or more of a plurality of rounding profiles and wherein the dynamic information corresponds to one of the rounding profiles to be applied to the particular repair order.

8. The system of claim 1 further comprising an inventory multiplier for scaling inventory information supplied by the interface to the DMS so that the supplied information corresponds to the scale of the inventory information and so that the inventory of the DMS is adjusted at a rate which corresponds to the actual use.

9. The system of claim 1 further comprising at least one of the following:
an alarm provided in the event that the dynamic information provided by the interface to the DMS is not received by the DMS;
retrying providing the dynamic information in the event that the dynamic information provided by the interface to the DMS is not received by the DMS; and/or
presenting an error message in the event that the dynamic information provided by the interface to the DMS is not received by the DMS.

10. The system of claim 1 wherein the computer includes a dispenser control for generating a text file indicative of fluids dispensed by the fluid dispenser.

11. The system of claim 1 wherein the DMS server has a database of repair orders and wherein the interface queries the database to generate a text file listing active and/or open repair orders.

12. The system of claim 10 wherein, in response to the received text file for fluids dispensed with regard to a particular repair order, the interface writes information corresponding to the received text file to the particular repair order in the database.

13. A computer implemented method for use with a dealer management system (DMS) for managing repair orders for repairs to be performed in a service department; and for use with a fluid dispensing system responsive to a service technician for dispensing fluids in the service department; the method comprising:
providing to the DMS dynamic information for a particular repair order, and
providing the information to the DMS in response to fluids dispensed by the fluid dispenser.

14. The method of claim 13 wherein the dynamic information includes dynamic pricing, further comprising providing to the DMS information specifying a price of the dispensed fluid based on the amount of fluid dispensed, said specified price applied to the particular repair order.

15. The method of claim 14 wherein the DMS maintains an inventory of the fluids and further comprising providing information to the DMS to relieve the inventory based on the amount of dispensed fluid independent of the amount of fluid on which the specified price is based.

16. The method of claim 13 wherein the dynamic information includes dynamic parts invoicing and further comprising providing to the DMS information identifying one or more parts to be added to the particular repair order along with a price for the dispensed fluid.

17. The method of claim 13 further comprising providing one or more of a plurality of profiles selected by a service technician via an input device and wherein the dynamic information corresponds to one of the profiles to be applied to the particular repair order.

18. The method of claim 17 wherein a particular profile comprises one of the following:
A profile designated as applicable for a particular time period;
A pricing profile;
A rounding profile,
An invoicing profile; and
An inventory profile.

19. The method of claim 13 further comprising providing one or more of a plurality of rounding profiles and wherein the dynamic information corresponds to one of the rounding profiles to be applied to the particular repair order.

20. The method of claim 13 further comprising providing an inventory multiplier for scaling inventory information supplied to the DMS so that the supplied information corresponds to the scale of the inventory information and so that the inventory of the DMS is adjusted at a rate which corresponds to the actual use.

21. The method of claim 13 further comprising at least one of the following:
Providing an alarm in the event that the dynamic information provided by the interface to the DMS is not received by the DMS;
retrying providing the dynamic information in the event that the dynamic information provided by the interface to the DMS is not received by the DMS; and/or
presenting an error message in the event that the dynamic information provided by the interface to the DMS is not received by the DMS.

22. A system comprising:
A dealer management system (DMS) for managing repair orders for repairs to be performed in a service department;
A fluid dispensing system responsive to a service technician for dispensing fluids in the service department;
A computer linking the dealer management system and the fluid dispensing system; and
A dispenser control executed by the computer for providing to the DMS dynamic information for a particular repair order, said dispenser control providing the information to the DMS in response to fluids dispensed by the fluid dispenser.

23. The system of claim 22 further comprising a plurality of input devices linked to the computer for inputting repair information relating to the repair orders, at least some of said input devices located within the service department and wherein the dynamic information includes dynamic pricing wherein the dispenser control provides to the DMS in real time information specifying a price of the dispensed fluid based on the amount of fluid dispensed and in response to repair information input via one of the input devices by a service technician, said specified price applied to the particular repair order.

24. The system of claim 23 wherein the DMS maintains an inventory of the fluids and wherein the dispenser control provides information to the DMS in real time to relieve the inventory based on the amount of dispensed fluid independent of the amount of fluid on which the specified price is based.

25. The system of claim 22 wherein the dynamic information includes dynamic parts invoicing wherein the dispenser control provides to the DMS in real time information identifying one or more parts to be added to the particular repair order along with a price for the dispensed fluid.

26. The system of claim 23 wherein the dispenser control is configurable to have one or more of a plurality of profiles selected by a service technician via one of the input devices and wherein the dynamic information corresponds to one of the profiles to be applied to the particular repair order.

27. The system of claim 26 wherein a particular profile comprises one of the following:
A profile designated as applicable for a particular time period;
A pricing profile;
A rounding profile,
An invoicing profile; and
An inventory profile.

28. The system of claim 22 wherein the dispenser control includes profiled rounding comprising said dispenser control configurable to have one or more of a plurality of rounding profiles and wherein the dynamic information corresponds to one of the rounding profiles to be applied to the particular repair order.

29. The system of claim 22 further comprising an inventory multiplier for scaling inventory information supplied by the dispenser control to the DMS so that the supplied information corresponds to the scale of the inventory information and so that the inventory of the DMS is adjusted at a rate which corresponds to the actual use.

30. The system of claim 22 further comprising at least one of the following:
an alarm provided in the event that the dynamic information provided by the dispenser control to the DMS is not received by the DMS;
retrying providing the dynamic information in the event that the dynamic information provided by the dispenser control to the DMS is not received by the DMS; and/or
presenting an error message in the event that the dynamic information provided by the dispenser control to the DMS is not received by the DMS.

31. The system of claim 22 wherein the computer receives at least one of a repair order number and a registration number relating to the particular repair order and wherein the received repair order number is verified by comparing it to an database of the DMS and wherein the received registration number is verified by comparing it to a database in the DMS.
